(19) United States
(12) Patent Application Publication
(10) Pub. No.: US 2020/0129382 A1
(43) Pub. Date: Apr. 30, 2020

(54) INFANT PACIFIER DEVICE

(71) Applicant: Trey Fellers, Fairhope, AL (US)

(72) Inventor: Trey Fellers, Fairhope, AL (US)

(21) Appl. No.: 16/174,478

(22) Filed: Oct. 30, 2018

(51) Int. Cl. A61J 17/00

(52) U.S. Cl. CPC A61J 17/008; A61J 17/02

(57) ABSTRACT

An infant pacifier device which may provide for preventing and/or reducing common orthodontic/orthopedic conditions. The device may include a bulb formed by an upper surface and an opposing lower surface. The lower surface may include a rear ascension. A neck having a descending neck, neck inversion, and an ascending neck. The descending neck may be coupled to the bulb, the ascending neck may be coupled to a shield, and the descending neck and ascending neck may be coupled together via the neck inversion so that the descending neck and ascending neck are angled relative to each other. A shield extension may be coupled to the shield so that the bulb and shield extension are positioned on opposing sides of the shield. Optionally, a neck valley forming a junction between the descending neck and ascending neck, and a nipple valley forming a junction between the rear ascension and the descending neck.

### FIELD OF THE INVENTION

This patent specification relates to the field of pacifiers for individuals such as infants. More specifically, this patent specification relates to a pacifier device configured to prevent orthodontic and orthopedic conditions.

### BACKGROUND

Many types of infant pacifiers are currently available. Typically, pacifiers have a nipple which an infant can suck and/or bite when positioned in their mouth and a mouth shield coupled to the nipple for preventing the infant from ingesting the pacifier. However, current pacifiers often contribute to or are unable to address orthodontic and orthopedic conditions such as Anterior Openbite, Posterior Crossbite, and even infections such as thrush.

Therefore, a need exists for novel pacifier devices. A further need exists for novel pacifier devices which are able to prevent and/or reduce the severity of the common orthodontic/orthopedic malformation know as Anterior Openbite. There is also a need for novel pacifier devices which are able to reduce the common orthodontic/orthopedic malformation know as Posterior Crossbite. Finally, a need exists for novel pacifier devices which are also able to provide other developmental benefits such as reducing bacterial stagnation and stimulating the growth and production of taste buds (papillae).

### BRIEF SUMMARY OF THE INVENTION

An infant pacifier device is provided. The unique elements of the device allow for the reduction of mouth opening when in use, thus preventing and/or reducing the severity of the common orthodontic/orthopedic malformation know as Anterior Openbite. Additionally, the device may be configured to help reduce the common orthodontic/orthopedic malformation known as Posterior Crossbite.

In some embodiments, an infant pacifier device may include a bulb formed by an upper surface and an opposing lower surface. The lower surface may include a rear ascension. A neck having a descending neck, neck inversion, and an ascending neck. The descending neck may be coupled to the bulb, the ascending neck may be coupled to a shield, and the descending neck and ascending neck may be coupled together via the neck inversion so that the descending neck and ascending neck are angled relative to each other. A shield extension may be coupled to the shield so that the bulb and shield extension are positioned on opposing sides of the shield.

In further embodiments, the device may include a neck valley forming a junction between the descending neck and ascending neck, and a nipple valley forming a junction between the rear ascension and the descending neck.

In still further embodiments, the device may include one or more prophy ridges. The prophy ridges may be configured to clean the dorsal aspect of the tongue reducing bacterial stagnation and to stimulate the growth/production of taste buds (papillae).

### BRIEF DESCRIPTION OF THE DRAWINGS

Some embodiments of the present invention are illustrated as an example and are not limited by the figures of the accompanying drawings, in which like references may indicate similar elements and in which:

FIG. 1-FIG. 1 depicts a top perspective view of an example of an infant pacifier device according to various embodiments described herein.

FIG. 2-FIG. 2 illustrates a side elevation view of an example of an infant pacifier device according to various embodiments described herein.

FIG. 3-FIG. 3 shows a sectional, through line 3-3 shown in FIG. 4, elevation view of an example of an infant pacifier device according to various embodiments described herein.

FIG. 4-FIG. 4 depicts a top plan view of an example of an infant pacifier device according to various embodiments described herein.

FIG. 5-FIG. 5 illustrates a bottom plan view of an example of an infant pacifier device according to various embodiments described herein.

FIG. 6-FIG. 6 shows a front elevation view of an example of an infant pacifier device according to various embodiments described herein.

FIG. 7-FIG. 7 depicts a rear elevation view of an example of an infant pacifier device according to various embodiments described herein.

FIG. 8-FIG. 8 illustrates a partial perspective bottom view of an example of a bulb of an infant pacifier device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

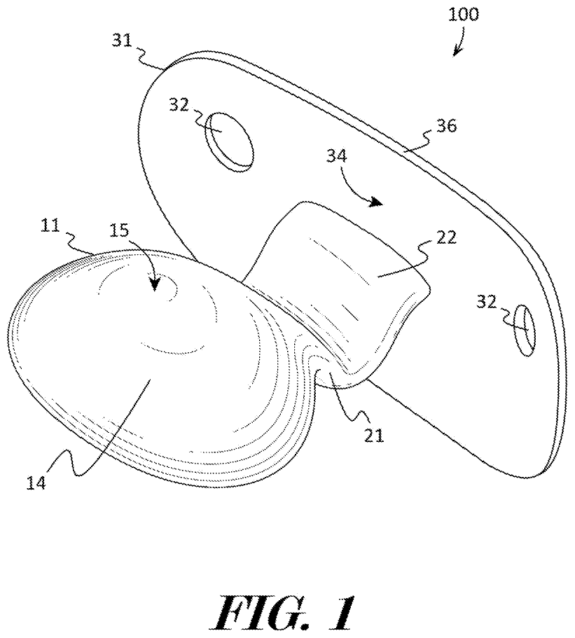

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new infant pacifier device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

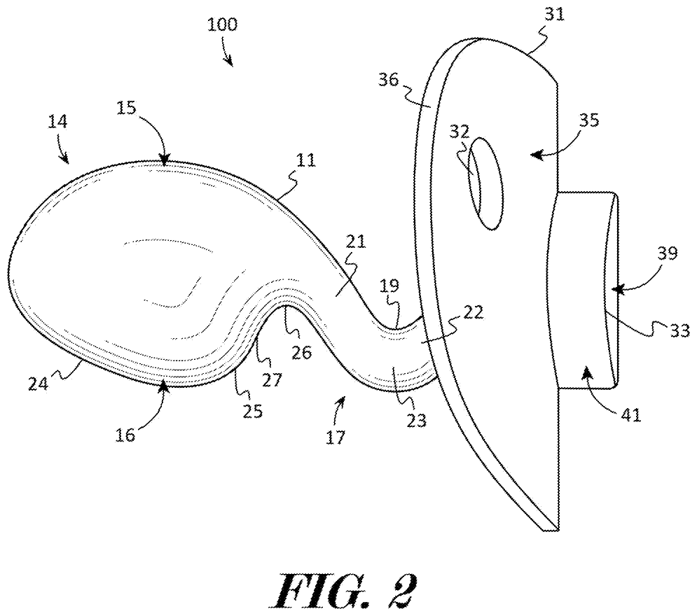

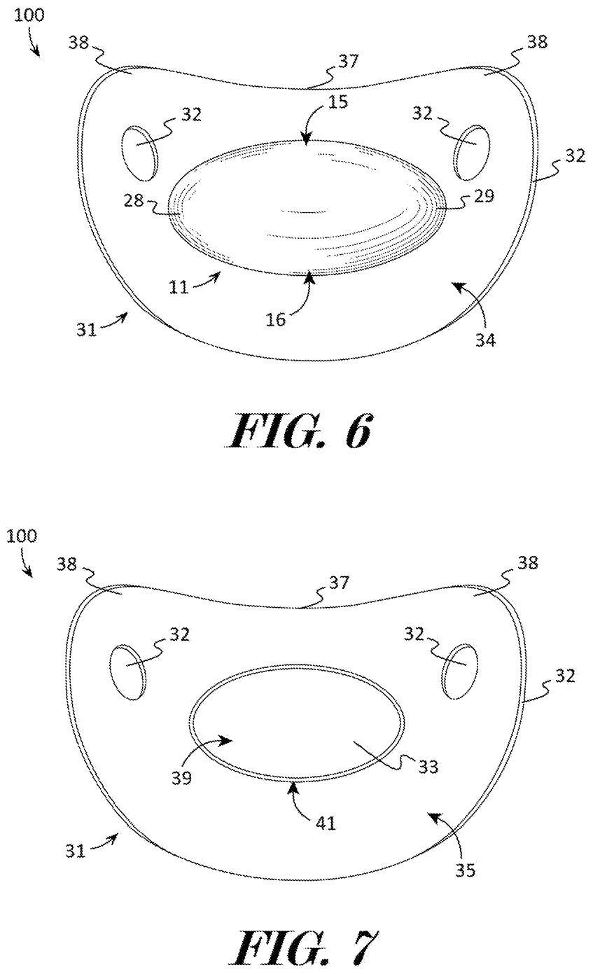

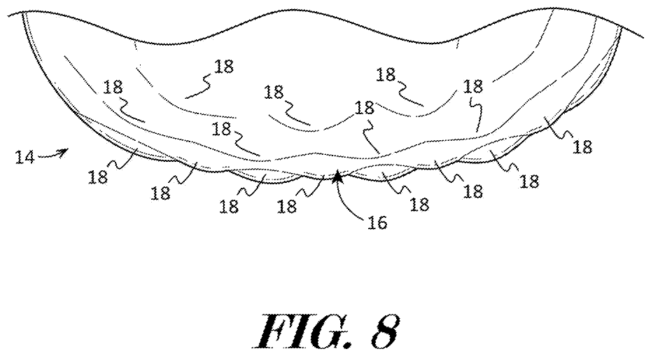

The present invention will now be described by example and through referencing the appended figures representing preferred and alternative embodiments. FIGS. 1-8 illustrate an example of an infant pacifier device (“the device”) 100 according to various embodiments. In some embodiments, the device 100 may comprise a nipple 11 having a bulb 14 and a neck 17. The neck 17 may be coupled to a shield 31. The bulb 14 may be formed by an upper surface 15 and an opposing lower surface 16. The lower surface 16 may comprise one or more prophy ridges 18. The neck 17 may include a descending neck 21, which may be coupled to the bulb 14, and an ascending neck 22, which may be coupled to the shield 31. The descending neck 21 and ascending neck 22 may be coupled together via a neck inversion 23. The shield 31 may comprise one or more apertures 32 which may extend through the shield 31. A shield extension 33 may be coupled to the shield 31 so that the bulb 14 and shield extension 33 are positioned on opposing sides of the shield 31.

The nipple 11 may be suitable for being received in the mouth of an individual, such as an infant. In preferred embodiments, a nipple 11 may be made from or comprise a flexible biocompatible material, such as medical grade durable rubber that is latex free. Other example flexible biocompatible materials include man-made polymers, such as silicones, poly (ethylene), poly (vinyl chloride), polyurethanes, polypropylene, Polymethylmetacrylate, Polytetrafluoroethylene, Polyamide, Polyethylenterephthalate, Polyethersulfone, polylactides, and Polyetherimide.

In some embodiments, all or portions of the nipple 11 may be generally solid. In other embodiments, all or portions of the nipple 11 may be hollow, so as to comprise one or more air or gas spaces. In preferred embodiments, a nipple 11 may comprise a bulb pocket 42 and/or neck pocket 43 which may comprise air, gas, or other material that is more easily compressed or deformed than the other material(s) that the nipple 11 may comprise. A bulb pocket 42 may be disposed within the bulb 14, and a neck pocket 43 may be disposed within the neck 17. In preferred embodiments, a bulb pocket 42 may be in communication with a neck pocket 43, while in other embodiments, a bulb pocket 42 and neck pocket 43 may be distinct from each other. A bulb pocket 42 and neck pocket 43 may be configured in any shape and size. In further embodiments, a bulb pocket 42 may be generally ovoid shaped such as to generally mimic the exterior shape of the bulb 14. In still further embodiments, a neck pocket 43 may be configured in a shape that may generally mimic the exterior shape of the neck 17. In further preferred embodiments, the ratio of the size of a bulb pocket 42 to the size of the bulb 14 may be larger than the ratio of the size of the neck pocket 43 to the size of the neck 17. This may allow the bulb 14 to be more compressible or deformable (to allow for a degree of flattening when the infant is sucking on the nipple 11) compared to the neck 17 so that the neck 17 may have relatively more rigidity with a lower profile to help in the reduction of the open bite. This not only allows for a more natural feel (replicating a mother's nipple) but also allows widening of the nipple 17 in a lateral dimension which will help in the reduction of the common malformation know as posterior crossbite.

In some embodiments, the nipple 11 may comprise a bulb 14 having a generally ovoid shape as shown in FIGS. 1-7. In other embodiments, a bulb 14 may comprise a generally spherical shape or any other shape, including combinations of shapes. The bulb 14 may comprise and/or be formed by an upper surface 15 and an opposing lower surface 16. In preferred embodiments, the upper surface 15 may comprise a generally concave curved shape relative to the lower surface 16. In further preferred embodiments, the lower surface 16 may comprise a generally concave curved shape relative to the upper surface 15. In further embodiments, the lower surface 16 may comprise a front slope 24, a rear curvature 25, and a rear ascension 27. Generally, the rear ascension 27 may be coupled to the neck 17 while the front slope 24 may be separated from the rear ascension 27 by the rear curvature 25. In still further embodiments, the front slope 24 and rear curvature 25 may both be generally concave curved shape relative to the upper surface 15 and the front slope 24 may have relatively less curvature than the rear curvature 25.

In some embodiments, the nipple 11 may comprise one or more prophy ridges 18. In preferred embodiments, one or more, such as a plurality of, prophy ridges 18 may be disposed on the lower surface 16, such as on the front slope 24 and/or rear curvature 25. In other embodiments, one or more, such as a plurality of, prophy ridges 18 may be disposed anywhere on the bulb 14, including on the upper surface 15, and/or neck 17. Generally, a prophy ridge 18 may comprise a protrusion that may extend away from or above a surface of the nipple 11, such as the lower surface 16. The prophy ridges 18 may function to clean the dorsal aspect of the tongue reducing bacterial stagnation and to stimulate the growth/production of taste buds (papillae). Additionally, prophy ridges 18 may help with prevention of localized bacterial colonization on the tongue and may help to reduce length of fungal infection know as Thrush by manual disruption of both bacteria and fungus. In preferred embodiments, a prophy ridge 18 may comprise a generally convex rounded shape that may extend away from or above a surface of the nipple 11, such as the lower surface 16. In other embodiments, a prophy ridge 18 may comprise a triangular prism shape, a rectangular prism shape, an annular or ring shape, or any other shape.

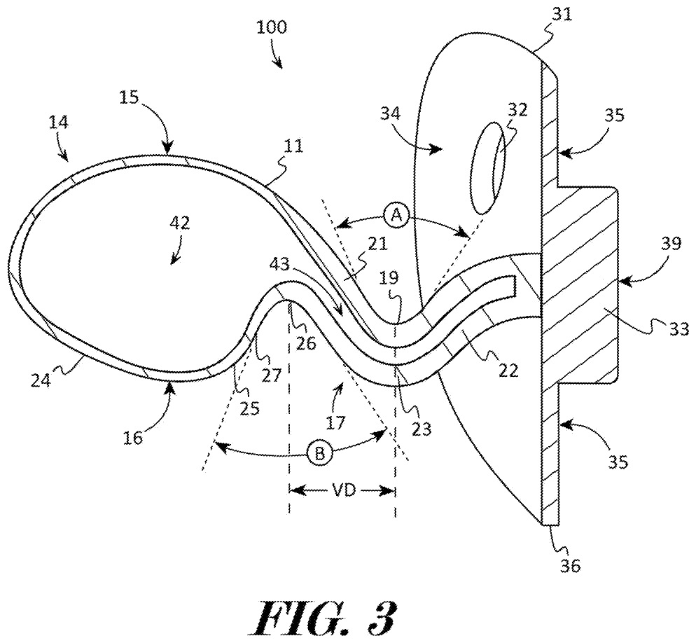

The bulb 14 may be coupled to the shield 31 via a neck 17. The neck 17 may be configured in any shape and size. In some embodiments, a neck 17 may comprise a descending neck 21, an ascending neck 22, and a neck inversion 23 which may generally form a U-shape. In further embodiments, the upper surface 15 and lower surface 16 of the bulb 14 may be coupled to the descending neck 21 while the ascending neck 22 may be coupled to the shield 31. The descending neck 21 and ascending neck 22 may be coupled together via the neck inversion 23. The neck inversion 23 may form a neck valley 19. Generally, the neck valley 19 may form a junction between the ascending neck 22 and the descending neck 21. In some embodiments, the descending neck 21 and ascending neck 22 may be angled relative to each other as shown with angle A in FIG. 3. In some embodiments, angle A may be between approximately 60 and 120 degrees, and more preferably between 80 and 100 degrees.

The lower surface 16, and preferably the rear ascension 27 of the lower surface 16, of the bulb 14 may be coupled to the descending neck 21 at a nipple valley 26. Generally, the nipple valley 26 may form a junction between the rear ascension 27 and the descending neck 21. In some embodiments, the rear ascension 27 of the lower surface 16 and descending neck 21 may be angled relative to each other as shown with angle B in FIG. 3. In some embodiments, angle B may be between approximately 60 and 120 degrees, and more preferably between 80 and 100 degrees.

As perhaps best shown in FIG. 3, the neck valley 19 may be closer to the shield 31 than the nipple valley 26. Generally, the neck valley 19 and the nipple valley 26 may be separated by a valley distance (VD). In some embodiments, the device 100 may comprise a VD of between approximately 10 and 20 millimeters. In preferred embodiments, the device 100 may comprise a VD of between 12 and 18 millimeters. In more preferred embodiments, VD may be approximately 15 millimeters. Generally, the neck valley 19, nipple valley 26, and the VD may specifically allow for a zero degree angle between the occlusal planes of the maxilla and mandible thus preventing the all too common malformation called Anterior Openbite which often times leads to the secondary habit of Tongue Thrust.

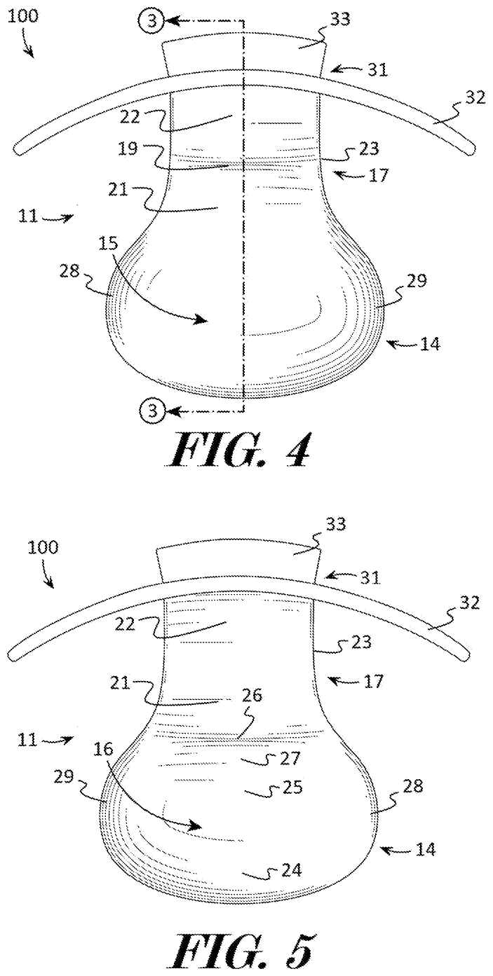

In some embodiments and as perhaps best shown in FIGS. 4 and 5, the bulb 14 may be configured to be wider than the neck 17. In preferred embodiments, the bulb 14 may comprise a first 28 and a second 29 nipple wing which may form the portions of the bulb 14 which may be wider than the neck 17. In further embodiments, a first 28 and a second 29 nipple wing may be configured so that the neck 17 may be between approximately 25 to 75 percent the width of the bulb 14. In this manner, the widened shape of the nipple in the lateral dimension of the bulb 14 versus the neck 17 will also help reduce the common orthodontic/orthopedic malformation known as Posterior Crossbite.

The ascending neck 22 may be coupled to the shield proximal surface 34. The shield 31 may also comprise a shield distal surface 35, and the shield proximal surface 34 may form opposing sides of the shield 31. The shield distal surface 35 and the shield proximal surface 34 may be coupled together via a shield perimeter 36. A shield 31 may be configured in any shape and size. In preferred embodiments, a shield 31 may be configured with a curved planar shape that may be concave curved towards the nipple 11. In further embodiments, a shield distal surface 35 and the shield proximal surface 34 may be configured with curved shapes that are relatively parallel or approximately equidistant from each other so that the shield perimeter 36 may be approximately uniform in dimension along its entirety.

In some embodiments, the shield 31 may comprise one or more perimeter depressions 37 and/or perimeter protrusions 38. Generally, a perimeter depression 37 may comprise a portion of the shield perimeter 36 that may be disposed between two perimeter protrusions 38 and which may be lower or closer to the central region of the shield 31, such as where the neck 17 and shield may be coupled.

In some embodiments, the shield 31 may comprise one or more apertures 32. An aperture 32 may pass through the shield 31, such as between the shield distal surface 35 and the shield proximal surface 34. In preferred embodiments, an aperture 32 may comprise a generally round or circular shape. In other embodiments, an aperture 32 may be configured in any shape and size. An aperture 32 may be positioned anywhere on the shield 31. In preferred embodiments, a shield 31 may comprise two apertures 32 which may be positioned above the neck 17 and shield 31 junction, such as relatively closer or proximate to a perimeter depression 37 and/or perimeter protrusion 38, and also positioned on opposing sides of the neck 17 and shield 31 junction.

In some embodiments, the device 100 may comprise a shield extension 33. A shield extension 33 may be positioned anywhere on a shield 31, such as on the shield distal surface 35. In preferred embodiments, a shield extension 33 may be positioned generally centrally on the shield distal surface 35 so that it may be positioned opposingly to the neck 17 and shield 31 junction. A shield extension 33 may be configured in any shape and size. In preferred embodiments, a shield extension 33 may comprise a generally oval shaped extension surface 39 which may be raised above or away from the shield distal surface 35 by an extension perimeter surface 41. Preferably, a shield extension 33 may be configured in a shape and size that is suitable for allowing a user to grasp or otherwise manipulate the device 100.

While some exemplary shapes and sizes have been provided for elements of the device 100, it should be understood to one of ordinary skill in the art that the nipple 11, shield 31, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An infant pacifier device, the device comprising:
a bulb formed by an upper surface and an opposing lower surface, the lower surface comprising a rear ascension;
a neck having a descending neck, neck inversion, and an ascending neck, wherein the descending neck is coupled to the bulb, wherein the ascending neck is coupled to a shield, and wherein the descending neck and ascending neck are coupled together via the neck inversion so that the descending neck and ascending neck are angled relative to each other;
a shield extension coupled to the shield so that the bulb and shield extension are positioned on opposing sides of the shield.

2. The device of claim 1, further comprising a prophy ridge.

3. The device of claim 1, wherein the lower surface comprises plurality of prophy ridges.

4. The device of claim 1, further comprising a bulb pocket.

5. The device of claim 1, further comprising a neck pocket.

6. The device of claim 5, further comprising a bulb pocket in communication with the neck pocket.

7. The device of claim 1, further comprising a neck valley forming a junction between the descending neck and ascending neck.

8. The device of claim 7, wherein the descending neck and ascending neck are angled between 60 and 120 degrees relative to each other.

9. The device of claim 1, further comprising a nipple valley forming a junction between the rear ascension and the descending neck.

10. The device of claim 9, wherein the rear ascension and descending neck are angled between 60 and 120 degrees relative to each other.

11. The device of claim 9, further comprising a neck valley forming a junction between the descending neck and ascending neck, wherein the neck valley and the nipple valley are separated by a valley distance (VD), and wherein VD is between 10 and 20 millimeters.

12. An infant pacifier device, the device comprising:
a bulb formed by an upper surface and an opposing lower surface, the lower surface comprising a rear ascension;
a neck having a descending neck, neck inversion, and an ascending neck, wherein the descending neck is coupled to the bulb, wherein the ascending neck is coupled to a shield, and wherein the descending neck and ascending neck are coupled together via the neck inversion so that the descending neck and ascending neck are angled relative to each other;
a neck valley forming a junction between the descending neck and ascending neck;
a nipple valley forming a junction between the rear ascension and the descending neck;
a shield extension coupled to the shield so that the bulb and shield extension are positioned on opposing sides of the shield.

13. The device of claim 12, further comprising a prophy ridge.

14. The device of claim 12, wherein the lower surface comprises plurality of prophy ridges.

15. The device of claim 12, further comprising a bulb pocket.

16. The device of claim 12, further comprising a neck pocket.

17. The device of claim 16, further comprising a bulb pocket in communication with the neck pocket.

18. The device of claim 12, wherein the descending neck and ascending neck are angled between 60 and 120 degrees relative to each other.

19. The device of claim 12, wherein the rear ascension and descending neck are angled between 60 and 120 degrees relative to each other.

20. The device of claim 12, wherein the neck valley and the nipple valley are separated by a valley distance (VD), and wherein VD is between 10 and 20 millimeters.
